(19) United States
(12) Patent Application Publication
(10) Pub. No.: US 2009/0042435 A1
(43) Pub. Date: Feb. 12, 2009

(54) MOLDED ELECTRICAL CONNECTOR AND METHOD OF MAKING SAME

(76) Inventors: Wilmsmann Ute, Halver (DE); Hans Werner Moller, Kierspe (DE)

Correspondence Address: K.F. ROSS P.C., 5683 RIVERDALE AVENUE, SUITE 203 BOX 900, BRONX, NY, 10471-0900, US

(21) Appl. No.: 12/186,653

(22) Filed: Aug. 6, 2008

(30) Foreign Application Priority Data
Aug. 10, 2007 (DE) 102007037749.7

(51) Int. Cl. H01R 3/00

(52) U.S. Cl. 439/491

(57) ABSTRACT

A connector assembly has a cable having at least one wire and a sheath surrounding the wire, a contact holder having a front end, a contact fixed in the holder, exposed at the front end, and connected to the wire with the wire is free of the sheath for a short distance from a rear end of the holder, a plastic body molded to the holder to an end of the cable sheath adjacent the holder and over the wire exposed between the sheath and the holder rear end, and an inlay only partially imbedded in the body in a non-detachable and visible manner.

### FIELD OF THE INVENTION

The present invention relates to a molded plug-type connector. More particularly this invention concerns such a connector that carries indicia and to a method of making the connector.

### BACKGROUND OF THE INVENTION

An electrical/electronic plug-type connector, which can be a plug or a socket mounted at the end of a cable and adapted to fit with another such socket or plug that can be mounted on a cable or on a piece of equipment, typically has a holder in which one or more wires are secured. The holder has a front end at which at least one conductor or a plug or socket element fixed to it is exposed so that when the front of the holder is fitted to a complementary plug or socket, an electrical connection is made. The cable in which the conductor(s) or wire(s) extend(s) projects from the rear end of the holder.

Typically the holder and the front end of the cable is imbedded in a body of plastic that not only solidly joins the holder to the cable, but also provides a good grip for the user of the cable and protects the wires or conductors extending from the cable into the holder. This body is injection molded to the holder and cable once its wires are joined to the holder.

Such connectors have long been known from obvious prior art. In general, they are used to connect electrical supply lines or lines for control commands to one another in order, for example, to connect a device or measuring unit to a control bus or a central power supply.

In addition to appropriate product quality, customers are placing an increasing demands on manufacturers of connector assemblies. As a rule, with the prevailing “just in time” production practices, purchasers of connector assemblies are increasingly ordering small quantities with specific delivery dates.

What is more, purchasers of connector assemblies require that these products, which up to now have been ordered as simple merchandise, must be designated as belonging to their company, meaning that the producers of connector assemblies must now produce connector assemblies with the purchaser's logo and/or color identifier.

However, the customer-specific individualization of connector assemblies presents considerable problems for manufacturers because they must frequently retool the production line, clean it, and run it in again until constant production parameters are reached, but each time only for a low number of units. This may be produced in a particularly simple manner using the example of injection molding.

If, after producing a connector assembly for Customer A, an order for Customer B must be completed, the device must first be cleaned, if the customer wants a specific color, an appropriately colored granulate must be used, and a mold part may need to be exchanged for applying a brand name. Then production must be started up again; first, some test injections must be made into the injection mold until the production conditions have again reached a constant parameter.

It is easy to understand that equipment costs have a disproportionate weight in the case of smaller lot sizes, for which reason up to now orders were collected until a certain minimum quantity was reached and then were processed. However, this is contrary to the need of the purchasers to receive even orders of small quantities of connector assemblies in as short an amount of time as possible.

More specifically, to make a standard prior-art connector a subassembly is formed of a contact holder and a cable. This subassembly is set in an injection-molding mold, and the mold cavity is filled with an appropriate mass of melted plastic. This production method is very simple and cost-effective and allows plugs to be produced in large numbers.

However, if, as discussed at the outset, individualized plugs are being produced, for example, with the impression of a logo, labeled with a brand name, or provided with a color designation, a retooling of the injection molding machine (not shown) is required for each batch of plugs The injection-molding machine must be cleaned, the plastic granulate must be exchanged, and it may also be necessary to exchange the parts of the injection molding mold, by means of which a logo is formed directly in the plastic material. Production is then resumed, although initially some waste must be expected until production parameters such as pressure and temperature are again stable. These retooling costs are disproportionate considering the small quantities required by the market.

First of all, the obvious solution to the problem, namely to use more injection molding machines, each of which is provided with a different colored plastic granulate and equipped for the production of precisely one type of plug, requires a relatively high one-time investment; moreover, even such small quantities may be produced only with relatively high costs. This is particularly due to the fact that injection molding machines are set up for continuous operation, such that the melted plastic located in the coil burns. As a result, it is also necessary in this obvious solution to switch off and clean the machines after the quantity of plugs ordered by the customer has been produced; when starting the machine back up, initially some waste must be expected until constant production parameters have been achieved.

Furthermore, in producing connector assemblies, in particular when imbedding and connecting contacts and cables using a plastic body, the problem exists that the cable is displaced so far in the plastic injection mold by the injection of the plastic injection mass that it rests against the inner wall of the injection mold during injection and is not correctly coated. As a result, the cable is not protected in this area and the connector assembly thus produced must be discarded. It is known to address this problem by providing the injection mold with rod-shaped positioning elements that are disposed across from the injection point and that hold the cable in a secure position for formation by injection molding. The disadvantage of this solution is that the connector assembly has a hollow space or a break in the body at this point. Especially in the production of foodstuffs, this represents a contamination risk, for which reason connector assemblies of this type are not normally usable there.

### OBJECTS OF THE INVENTION

It is therefore an object of the present invention to provide an improved molded electrical connector and method of making same.

Another object is the provision of such an improved molded electrical connector and method of making same that overcomes the above-given disadvantages, in particular that can create a connector assembly that may be produced in a small series in a cost-effective and rational manner even when being marked with different designations.

### SUMMARY OF THE INVENTION

A connector assembly has according to the invention a cable having at least one conductor and a sheath surrounding the conductor, a contact holder having a front end, a contact fixed in the holder, exposed at the front end, and connected to the conductor with the wire is free of the sheath for a short distance from a rear end of the holder, a plastic body molded to the holder to an end of the cable sheath adjacent the holder and over the conductor exposed between the sheath and the holder rear end, and an inlay only partially imbedded in the body in a non-detachable and visible manner.

The embedding of an inlay into the plastic body of a standardized plug allows small-series production in a particularly simple manner. From prior production periods and running orders, it is possible to approximate how many connector assemblies must be produced for a customer in the upcoming production period. The inlays according to the invention may be produced in advance in accordance with client-specific requests and then held in reserve.

The injection mold for the standardized connector assembly is provided with a seat for the inlay into which the inlay must be placed before the injection of the injection molding mass. As a result, by simply exchanging the inlay according to the invention, it is possible to produce a connector element with customer-specific indicia without needing to perform a time-consuming retrofit of the production machines. In fact production can continue with one customer's batch directly following another's.

Because the inlays are quite inexpensive components, the possibility of an overstock is not of particular consequence. It is also possible for connector assemblies to be produced in a problem-free fashion that do not have any mark at all, simply by not filling the recess provided for the inlay.

In summary, using the features of the invention 1, the problem of producing individualized connector assemblies in small batches is solved in a surprisingly simple fashion while, at the same time, being extremely advantageous because the ongoing production process basically need not be interrupted.

According to another feature of the invention an inlay embodied as a positioning element is embedded in the plastic body that holds the conductor(s) of the cable in a central position relative to the axis of the plastic body during injection molding.

When injection molding, i.e., when producing the plastic body, the cable is pressed against the inlay by the injection pressure of the injected mass. The inlay in turn is positioned in such a way that the cable cannot be pressed all the way out to the outer surface of the plastic body to be produced. This guarantees the secure positioning of the cable in a central region relative to the axis of the plastic body.

In a preferred embodiment, the positioning element is visibly embedded in the plastic body such that the positioning element also serves as a marking element to which all of the advantages mentioned above apply.

In a particularly preferred embodiment, provision is made for the inlay to protrude from the outer surface of the plastic body, which significantly improves its marking function.

It has been shown that ring-shaped or rod-shaped inlays are particularly suitable.

Moreover, it is advantageous for the inlay to have projections facing the cable that hold the cable in a central position relative to the axis of the plastic body.

### BRIEF DESCRIPTION OF THE DRAWING

The above and other objects, features, and advantages will become more readily apparent from the following description, reference being made to the accompanying drawing in which:

FIG. 1 is a perspective view of a completed connector according to the invention;

FIG. 2 is a similar view of the connector before molding in place of its plastic body;

FIG. 3 is an end view of the identifier ring in accordance with the invention;

FIG. 4 is a cross section through the connector of FIG. 1 before being imbedded in plastic;

FIG. 5 is a cross section through another connector according to the invention;

FIG. 6 is a top view of a mold half for creating the connector of FIG. 1; and

FIG. 7 is a view like FIG. 6 of another mold half according to the invention.

### SPECIFIC DESCRIPTION

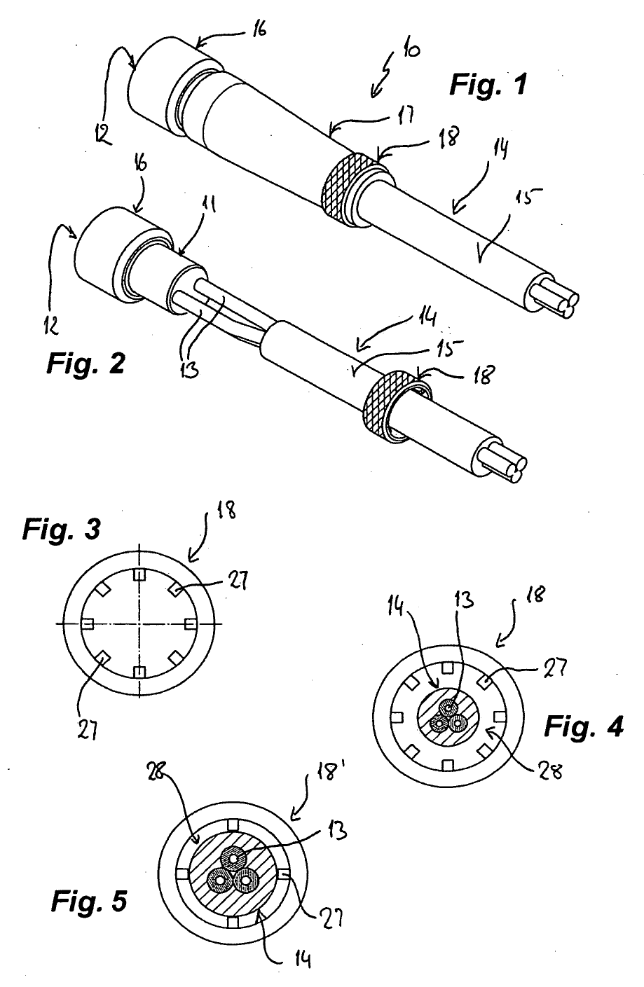

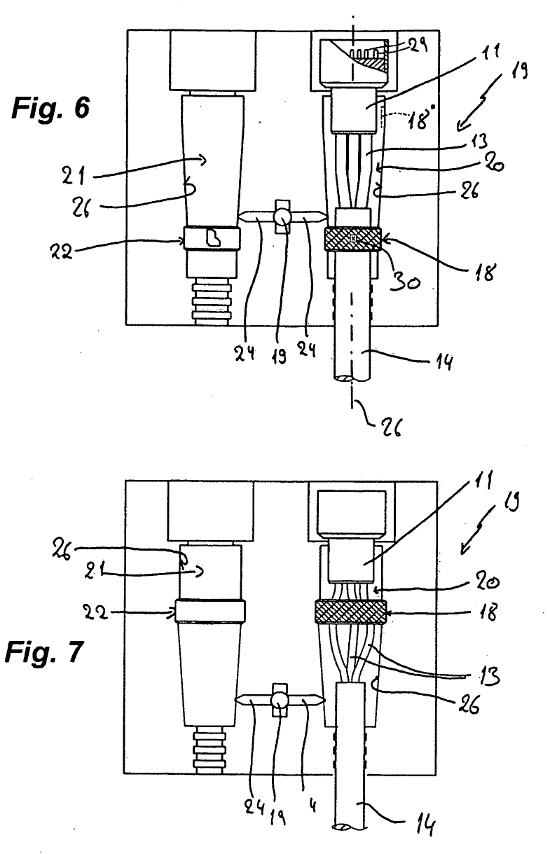

As seen in FIG. 1 a plug 10 of a connector assembly has a contact holder 11 in which unillustrated contacts 29 (FIG. 6 only) formed as plug pins or sockets are mounted for creating an electrical connection with opposing contacts of a socket. The contacts of the contact holder 11 are connected to conductors of insulated wires 13 of a three-conductor cable 14 on a side facing away from a plug front 12, with the wires 13 being encased in the cable 14 by a casing 15. Moreover, a coupling nut 16 is arranged on the front end 12 of contact holder 11 for the joining the plug 10 and a socket (not shown) to one another. The contact holder 11 and cable 14 are combined into one unit by means of a plastic body 17 shown in FIG. 1, with the plastic body 17 being molded around the cable 14 and contact holder 11 by injection molding. During injection, an inlay 18 is embedded in the plastic body 17, which is shown in detail in FIG. 3. This inlay 18 carries as shown in FIG. 6 an indicia 30 that can be a company name or the like. Otherwise the outside surface of the ring 18 is knurled so it can be used as a finger grip for plugging and unplugging the connector 10.

With the aid of the inlay 18 according to the invention, the problem of producing small, individualized quantities may be easily solved. The inlay 18 is pre-fabricated and kept in inventory and inserted into the injection molding mold 19 in the course of the production process along with the pre-assembled unit composed of the contact holder 11 and the cable 14. When producing the plastic body 17 by injection molding, the inlay 18, here an insertion ring arranged coaxially to the cable, is embedded in the plastic body 17. Thus, a rational small-batch production of individually designated plugs 10 is possible. The inlay 18 is of heat-resistant material, normally a thermosetting resin.

In producing the individual parts of a connector assembly, for example, plugs 10, another problem arises that may be seen particularly easily from FIGS. 6 and 7.

There, an injection molding mold shown schematically in its entirety at 19 has a mold cavity 20 in which is fitted a subassembly comprised of a contact holder 11 with attached wires 13 of a cable 14 as well as an inlay 18.

A second mold cavity into which nothing has yet been inserted is shown at 21. A recess 22 of the second mold cavity 21 serves to accommodate the inlay 18 and holds it in place in the injection-molding mold 19 during injection of molten plastic. The injection molding mold 19 further has a central feed channel 23 for injecting the melted plastic, which flows from there into the mold cavities 20 and 21 via two supply channels 24.

When the melted plastic is injected via the supply channels 24, the cable 14 and/or the wires 13 may be pushed out of their central position relative to a plastic body axis 25. In the least favorable case, the cable 14 or the wires 13 rest against a wall 26 of the mold cavities 20 and/or 21 and are not correctly surrounded by the plastic body 17. A defective plug 10 produced in this manner is a reject.

According to the invention, in order to prevent cables 14 or wires 13 from resting against the wall 26 of the mold cavity 20 or 21, the inlay 18, here in the form of a positioning ring, is positioned in the region of the cable 14 (FIG. 6) or the wires 13 (FIG. 7) and holds the wires 13 or cable 14 in a central region relative to the plastic body axis 25 and at a distance from the inner wall 26 of the cavity 20.

The inlay 18 is shown more precisely in FIG. 3. It is a ring that has projections or prongs 27 pointing radially inward its central axis or at the cable 14 that serve to position the cable 14 during injection in a precise fashion and that anchor it solidly in the plastic body 17 once it has cured. FIGS. 4 and 5 each show a radial section of a plug 10 in the region of the inlay 18 or positioning element 18. In FIG. 5, a comparatively strong cable 14 is selected that rests against the surfaces of the projections 27 facing inward with its outer circumference. Here also, a ring 18′ is shown with only four prongs 27, as opposed to eight in FIGS. 3 and 4.

In contrast, a lighter cable 14 has been selected in FIG. 4, which is mounted at a distance from the inner surfaces of the projections 27 facing the cable 14 inside the inlay ring 18. Between the outer surface of the cable 14 and the inner surface of the inlay ring 18 is a gap 28 through which the melted plastic may pass during the production of the plastic body 17 such that the insertion ring 18, whether it is being used as a positioning element or only as a marking or labeling element, may be firmly embedded in the plastic body 17. Since the inner surface of the inlay ring 18 is below the outer surface of the finished plastic body 17, even if it is in direct engagement with the wires 13, it will hold them deeply enough in the body 17 that they will not be exposed.

It is obvious that an inlay 18 being used to position the cable may serve at the same time as a marking or labeling element as long as it is embedded in the plastic body 17 in such a way that the indicia 30 is visible from the outside. For this purpose, it is advantageous for the inlay 18, regardless of whether it is a pure marking element or also a positioning element, to project from the outside surface of the plastic body 17. The invention is also not limited to ring-shaped inlays 18. Inlays 18 in the shape of a half-shell or a bar are suitable for marking and for positioning, as shown at 18″ in dashed lines in FIG. 6.

In summary, by using an inlay 18 that may be produced in a cost-effective fashion, the invention is able to deal with two problems in the production of plugs 10 in a surprisingly easy manner. On the one hand, simple individualization in the form of a marking is possible without interrupting series production; on the other hand, the invention allows the secure positioning of the cable 14 in a central region relative to the plastic body axis 25.

When the secure positioning of the cable is not necessary and the individualization of the plug 10 is not required, the step of inserting the inlay 18 into the plastic injection molding mold 19 is omitted. When injecting the melted plastic through the supply channels 24 into the mold cavities 20 and 21, the recess 22 is then simply filled in as well, and the finished body 17 has an annular ridge. It is thus obvious that the inlay 18 according to the invention may be included in the current series production of connector assemblies in an extremely simple fashion.

We claim:

1. A connector assembly comprising:
a cable having at least one wire and a sheath surrounding the wire;
a contact holder having a front end and a rear end;
a contact fixed in the holder, exposed at the front end, and connected to the wire with the wire free of the sheath for a short distance adjacent the rear end;
a plastic body molded over the rear end of the holder and to an end of the cable sheath adjacent the holder and embedding the wire exposed between the sheath and the holder rear end; and
an inlay imbedded in the body and visible from outside the body.

2. The assembly defined in claim 1 wherein the inlay has an exposed outer face provided with an indicia.

3. The assembly defined in claim 1 wherein the inlay is provided between the sheath of the cable and the rear end of the holder.

4. The assembly defined in claim 1 wherein the inlay is a ring surrounding the wire between the sheath of the cable and the rear end of the holder.

5. The assembly defined in claim 4 wherein the ring has an outer surface provided with indicia.

6. The assembly defined in claim 4 wherein the ring projects outwardly past an outer surface of the body.

7. The assembly defined in claim 4 wherein the cable has a plurality of the wires that are insulated and that all pass through the ring.

8. The assembly defined in claim 4 wherein the outside surface of the ring is knurled.

9. The assembly defined in claim 4 wherein the ring has a plurality of inwardly projecting prongs anchoring the ring in the body.

10. The assembly defined in claim 1 wherein the inlay is a bar.

11. A connector assembly comprising:
a cable having at least one wire and a sheath surrounding the wire;
a contact holder having a front end and a rear end;
a contact fixed in the holder, exposed at the front end, and connected to the wire with the wire free of the sheath for a short distance adjacent the rear end;
a plastic body molded over the rear end of the holder and to an end of the cable sheath adjacent the holder and embedding the wire exposed between the sheath and the holder rear end; and
an inlay imbedded in the body, engaging the wire between the rear end and the sheath, and holding the wire between the rear end and the sheath beneath an outer surface of the body.

12. The assembly defined in claim 11 wherein the inlay has an exposed outer face provided with an indicia.

13. The assembly defined in claim 11 wherein the inlay is provided between the sheath of the cable and the rear end of the holder.

14. The assembly defined in claim 11 wherein the inlay is a ring surrounding the wire between the sheath of the cable and the rear end of the holder.

15. The assembly defined in claim 14 wherein the ring has an outer surface provided with indicia.

16. The assembly defined in claim 14 wherein the ring projects outwardly past an outer surface of the body.

17. The assembly defined in claim 14 wherein the cable has a plurality of the wires that are insulated and that all pass through the ring.

18. The assembly defined in claim 14 wherein the outside surface of the ring is knurled.

19. The assembly defined in claim 14 wherein the ring has a plurality of inwardly projecting prongs anchoring the ring in the body.

20. The assembly defined in claim 11 wherein the inlay is a bar.
